(19) United States
(12) Patent Application Publication
(10) Pub. No.: US 2026/0113147 A1
(43) Pub. Date: Apr. 23, 2026

(54) APPARATUS, METHODS, AND COMPUTER PROGRAMS FOR DECODING PME-HARQ DATA

(71) Applicant: Research & Business Foundation SUNGKYUNKWAN UNIVERSITY, Suwon-si (KR)

(72) Inventors: SANG-HYO KIM, Suwon-si (KR); Jisang PARK, Suwon-si (KR); HYO SANG JU, Suwon-si (KR)

(73) Assignee: Research & Business Foundation SUNGKYUNKWAN UNIVERSITY, Suwon-si (KR)

(21) Appl. No.: 19/002,287

(22) Filed: Dec. 26, 2024

(30) Foreign Application Priority Data
Dec. 26, 2023 (KR) 10-2023-0190858

(51) Int. Cl. H04L 1/00; H04L 1/1812

(52) U.S. Cl. CPC H04L 1/0054; H04L 1/1812

(57) ABSTRACT

The present disclosure relates to a technology for decoding encoded data based on PME-HARQ. In accordance with an aspect of the present disclosure, there is provided a PME-HARQ-based data decoding device, comprising: at least one first decoding unit that performs successive cancellation-based decoding on PME-HARQ-based data; at least one second decoding unit that performs polar code permutation-based decoding on the PME-HARQ-based data; and a decoding result selection unit that selects one of decoding results of the first decoding unit and decoding results of the second decoding unit based on a reliability of the decoding results of the first decoding unit and a reliability of the decoding results of the second decoding unit.

### CROSS REFERENCE TO RELATED APPLICATION

The present application claims priority to Korean Patent Application No. 10-2023-0190858, filed on Dec. 26, 2023, the entire contents of which is incorporated herein for all purposes by this reference.

### TECHNICAL FIELD

The present disclosure relates to a technology for decoding encoded data based on PME-HARQ. This work was supported by National Research Foundation of Korea (NRF) grant funded by the Korean government (Ministry of Science and ICT) (Project unique No.: 1711189752; Project No.: 2021R1A2C1008913; R&D project: Individual Basic Research (Ministry of Science and Technology); Research Project Title: Research on channel codes and application technologies for B5G and 6G communications; and Project period: 2023 Mar. 1˜2024 Feb. 29), Korea Institute of Energy Technology Evaluation and Planning grant funded by the Korea government (Ministry of Trade, Industry and Energy) (Project unique No.: 1415181967; Project No.: 20224000000440; R&D project: Energy human resources training; Research Project Title: Sector coupling energy industry advanced human resource development; and Project period: 2022 Jul. 1˜2023 Dec. 31), Institute of Information & communications Technology Planning & Evaluation (IITP) grant funded by the Korea government (Ministry of Science and ICT) (Project unique No.: 2710008295; Project No.: 00398449; R&D project: Broadcasting and Communication Industry Technology Development; Research Project Title: Network Research Center (NRC): Channel code decoding and channel estimation technology for communication generation evolution; and Project period: 2024 Apr. 1˜2031 Dec. 31), and National Research Foundation of Korea (NRF) grant funded by the Korean government (Ministry of Science and ICT, P71) (Project unique No.: 2710004592; Project No.: 00343913; R&D project: Personal Basic Research (Ministry of Science and Technology) (162111015015512001234301); Research Project Title: Research on next-generation channel code technology that ensures code diversity for ultra-reliable, low-latency communications; and Project period: 2024 May 1˜2026 Apr. 30).

### BACKGROUND

A polar code is an error correction code that is newly adopted as a control channel code in 5G new radio (NR). In order to overcome performance limitations of a successive cancellation (SC) decoding method, a successive cancellation list (SC-list (SCL)) decoding method was developed. Thereafter, the SCL decoding method has achieved performance surpassing that of a convolution code, which is a control channel code of 4G long-term evolution (LTE), through additional performance improvements based on cyclic redundancy check (CRC).

HARQ is a technology that combines automatic repeat request (ARQ) and forward error correction (FEC), and is a technology that increases the success rate of data restoration through a process of requesting retransmission of transmitted data when a receiving end fails to decode the transmitted data. In particular, the HARQ based on an incremental redundancy (IR) method transmits different parts of a data packet at each transmission stage of the HARQ for the purpose of improving throughput.

Polarization matrix extension (PME)-based HARQ, which is proposed as a method of HARQ for polar codes, extends a codeword length in the retransmission stage and then transmits newly generated codeword bit parts. In particular, among the newly generated bits at a source end, bits with higher reliability than the existing information bits are generated, and values of the information bits with lower reliability are copied and assigned to positions of these bits and then encoded. By reflecting these bit value assignment rules during decoding, excellent performance can be achieved compared to a chase combing (CC) method in an AWGN channel, but the decoding performance deteriorates in the retransmission stage over a fading channel due to characteristics of a kernel structure of polar codes.

A permutation decoding method, which is another method of improving decoding performance of polar codes, is a technology that uses multiple log-likelihood ratio (LLR) permutation patterns corresponding to kernel layer permutation patterns of a polar code to increase decoding success probability. In the process of permuting the LLR, the order of source bits is also permuted in the same way, and when the permutation decoding method is used with the SC or SCL decoding method, the performance is improved by utilizing the effect of rearranging the order of bit estimation. However, it has been empirically confirmed that the influence of reliability of the source bit due to the fading of the transmission channel connected to the polar code kernel does not change even if any LLR permutation pattern is used. The present invention provides a decoding method and device capable of supplementing PME HARQ performance based on the confirmation, and an operating method thereof.

### SUMMARY

An embodiment may provide a technology for decoding data based on PME-HARQ.

An embodiment may provide a technology for decoding data based on PME-HARQ that is capable of improving decoding performance even in a fading channel.

In accordance with an aspect of the present disclosure, there is provided a PME-HARQ-based data decoding device, comprising: at least one first decoding unit that performs successive cancellation-based decoding on PME-HARQ-based data; at least one second decoding unit that performs polar code permutation-based decoding on the PME-HARQ-based data; and a decoding result selection unit that selects one of decoding results of the first decoding unit and decoding results of the second decoding unit based on a reliability of the decoding results of each decoding unit.

The second decoding unit may include a permutation module that performs LLR permutation on the PME-HARQ-based data based on a permutation pattern to calculate an estimated value of a codeword; a decoder that performs successive cancellation-based decoding on the estimated value; and an inverse permutation module that performs LLR inverse permutation on the decoding result of the second decoding unit.

The device further comprising: a retransmission count confirmation unit that confirms a number of times the PME-HARQ-based data is retransmitted, wherein different decoders are each selected from among a plurality of decoders according to a number of times of retransmissions, and the first decoding unit and the second decoding unit are included in one of the plurality of decoders.

A number of the second decoding units may be plural, and a permutation pattern used by each of a plurality of second decoding units may be configured so that a decoding order determined by all parity pairs is inverted.

The PME-HARQ-based data may have different code lengths according to a number of times of retransmissions.

The permutation pattern may be set differently according to a number of message bits included in the PME-HARQ-based data. Here, there may be a single permutation pattern proper for all message sizes (the number of message bits).

The permutation pattern may be determined based on a channel reliability of a message bit included in the PME-HARQ-based data.

The PME-HARQ-based data may be the t-th (natural number greater than or equal to 1) retransmitted data after an initial transmission failure.

The successive cancellation-based decoding may be successive cancellation (SC) decoding or a successive cancellation list (SCL).

The decoding result selection unit may compare the reliabilities using a maximum likelihood determination method and selects the decoding result of one of the first decoding unit and the second decoding unit.

In accordance with another aspect of the present disclosure, there is provided a method for decoding PME-HARQ-based data performed by a PME-HARQ-based data decoding device, the method comprising: performing, by using at least one first decoding unit, successive cancellation-based decoding on PME-HARQ-based data; performing, by using at least one second decoding unit, polar code permutation-based decoding on the PME-HARQ-based data; and selecting one of decoding results of the first decoding unit and decoding results of the second decoding unit based on a reliability of the decoding results of the first decoding unit and a reliability of the decoding results of the second decoding unit.

In accordance with another aspect of the present disclosure, there is provided a non-transitory computer-readable storage medium storing a computer program, wherein the computer program, when executed by a processor, comprises an instruction for causing the processor to perform a method comprises performing, by using at least one first decoding unit, successive cancellation-based decoding on PME-HARQ-based data; performing, by using at least one second decoding unit, polar code permutation-based decoding on the PME-HARQ-based data; and selecting one of decoding results of the first decoding unit and decoding results of the second decoding unit based on a reliability of the decoding results of the first decoding unit and a reliability of the decoding results of the second decoding unit.

According to an aspect of the present invention, it is possible to improve the technology for decoding data based on PME-HARQ.

In addition, according to another aspect of the present invention, it is possible to provide a technology for decoding data based on PME-HARQ that is capable of improving decoding performance even in a fading channel.

### BRIEF DESCRIPTION OF THE DRAWINGS

FIGS. 1 to 7 are diagrams for describing encoding and decoding of data based on the conventional PME HARQ.

FIG. 8 is a block diagram of a PME-HARQ-based data decoding device according to an embodiment of the present invention.

FIG. 9 is a flowchart of a method of decoding PME-HARQ-based data according to an embodiment of the present invention.

FIGS. 10 to 14 are diagrams for describing a permutation pattern according to an embodiment of the present invention.

FIG. 15 is a block diagram of a PME-HARQ-based data decoding device according to another embodiment of the present invention.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

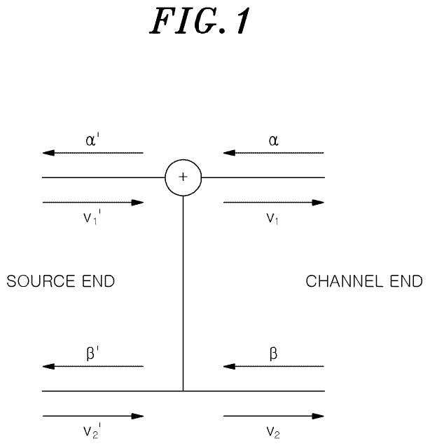

FIGS. 1 to 7 are diagrams for describing encoding and decoding of data based on the conventional PME HARQ.

A polar code is designed by using the phenomenon that the reliability of each bit channel is polarized during an encoding process of a source bit. The reliability of each bit is evaluated through bit channels

$${W}_{n}^{( i )}$$

(i=0, 1, . . . , N−1) defined by synthesizing and separating N=2ⁿ transmission channels, and methods such as density evolution and Gaussian approximation have been proposed. As an example, the reliability of bits is evaluated using a polarization weight (PW). It is determined that the larger the weight, the higher the reliability of the corresponding bit. The PW value for the bit whose binary representation of a bit index [i_{b,n-1}, . . . , i_{b,1}, i_{b,0}] is as shown in Equation 1.

$$PW = {\sum }_{j = 0}^{n - 1} {{i}_{b , j} ( {2}^{1 / 4} )}^{j} \qquad [ Equation 1 ]$$

For example, an SC decoding method and an SCL decoding method are used as basic polar code decoding methods. The two decoding methods commonly execute LLR and partial sum update operations according to Equation 2 in all polarization units inside a kernel.

$${α}^{′} = sgn ( α ) sgn ( β ) min \{ \vert α \vert , \vert β \vert \} \qquad [ Equation 2 ]$$

$${β}^{′} = {( - 1 )}^{{v}_{1}^{′}} α + β$$

$${v}_{1} = {v}_{1}^{′} ⊕ {v}_{2}^{′}$$

$${v}_{2} = {v}_{2}^{′}$$

The polarization unit is as illustrated in FIG. 1, and α, β, α′, and β′ each represent LLR of channel and source ends, and

$${v}_{1} , {v}_{2} , {v}_{1}^{′} , and {v}_{2}^{′}$$

represents partial sums. In the polarization unit closest to the source end, each source bit value is estimated based on the LLR values α′, β′. A method of estimating a source bit value will be described later in a decoding procedure of PME HARQ.

A permutation decoding method of polar codes is a method of improving the polar code decoding performance by permuting a kernel layer of a polar code decoder. In the previous study, it was confirmed that there is the permutation pattern of the channel LLR and that of the source bits corresponding to a kernel layer permutation pattern σ, and when the LLR permutation is applied together with the SC and SCL decoding methods, an effect occurs where the estimated order of source bits changes.

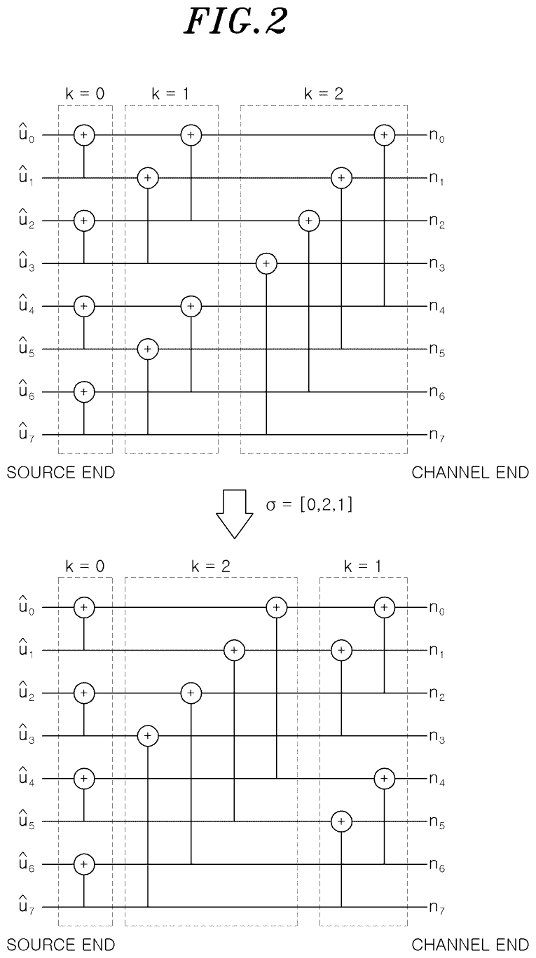

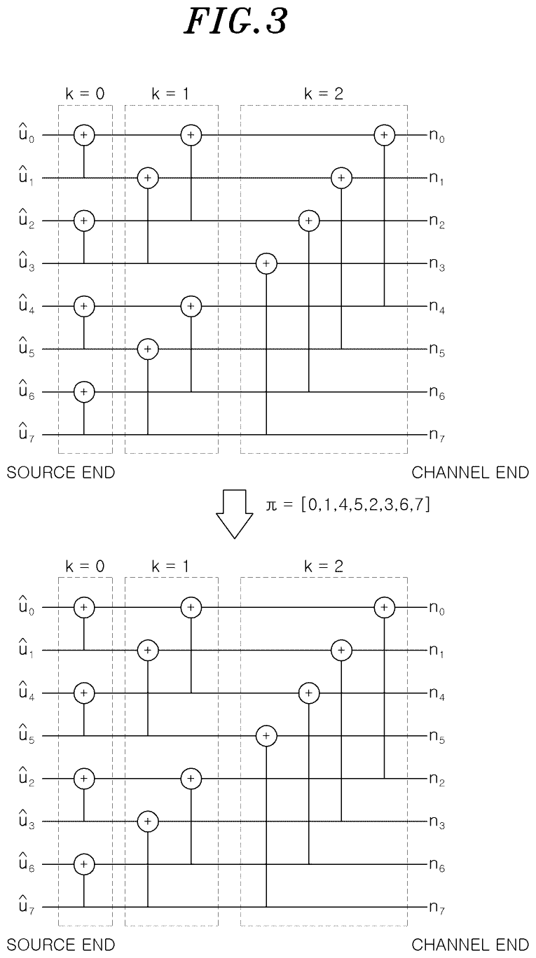

FIGS. 2 and 3 each illustrate the kernel permutation pattern at N=8 and the LLR and source bit permutation pattern corresponding to the kernel permutation pattern. FIG. 2 illustrates a decoder graph change due to a kernel layer permutation pattern σ=[0,2,1] when the kernel layer is placed in k=0, 1, 2 in the order of a channel end from the source end. In FIG. 3, when a binary representation of each bit index is placed as i [symbol] [i_{b,2}, i_{b,1}, i_{b,0}], it may be confirmed that i_{b,k} is mapped to a kernel layer k, and the result of permuting i_{b,1} and i_{b,0} instead of the kernel layer according to the σ pattern matches the LLR permutation pattern

$$π = [ 0 , 1 , 4 , 5 , 2 , 3 , 6 , 7 ] .$$

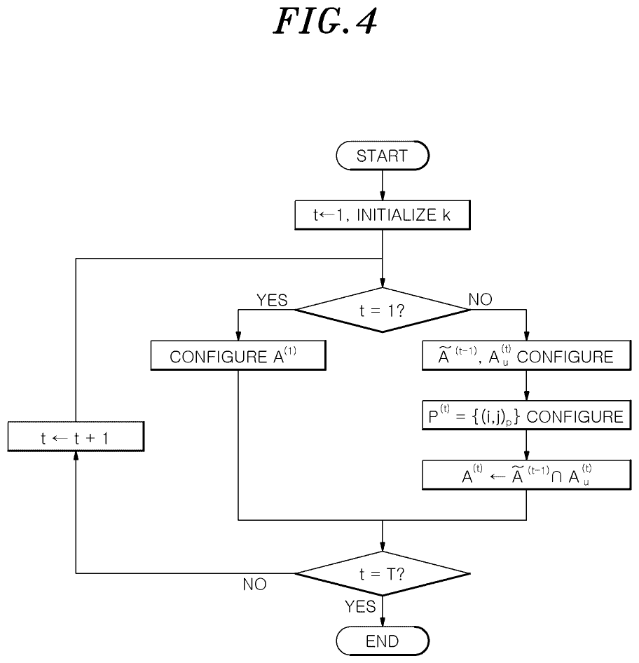

In a PME HARQ scenario, a code length is extended for each transmission stage to transmit a message. A code design method according to each transmission stage is illustrated in FIG. 4.

(N⁽¹⁾, K) polar codes used in an initial transmission stage (t=1) are designed by configuring [symbol] at positions of K superior bits according to the method of evaluating bit reliability. (N^{(t)}, K) polar codes used in a retransmission stage (t≥2) first secure

$${\tilde{𝒜}}_{u}^{( t )} = \{ i ∈ {𝒜}_{u}^{( t - 1 )} \vert i + {N}_{m}^{( t )} - {N}_{m}^{( t - 1 )} \}$$

from (N^{(t-1)}, K) polar codes and

$${𝒜}_{u}^{( t )}$$

from (N^{(t)}, K) polar codes, and then applies 1:1 mapping of a bit value at a position belonging to

$${\tilde{𝒜}}_{u}^{( t - 1 )} ∖ {𝒜}_{u}^{( t )}$$

to a position belonging to

$${𝒜}_{u}^{( t )} ∖ {\tilde{𝒜}}_{u}^{( t - 1 )}$$

to configure [symbol] and

$${𝒜}^{( t )} = {\tilde{𝒜}}^{( t - 1 )} ⋃ {𝒜}_{u}^{( t )} \cdot {N}_{m}^{( t - 1 )} = {2}^{{n}^{( t - 1 )}} and {N}_{m}^{( t )} = {2}^{{n}^{( t )}}$$

represent mother code lengths in (t−1)-th and t-th transmission stages.

$${𝒜}_{u}^{( t )}$$

represents and index set of K bits with the highest reliability among indexes from 0 to

$${N}_{m}^{( t )} - 1.$$

For example, when information of K=12 bits is initially transmitted in N⁽¹⁾=16 and then transmitted in N⁽²⁾=32, reliability sequences of the polar codes in the initial transmission and one-time retransmission stage are {15, 14, 13, 11, 7, 12, 10, 9, 6, 5, 3, 8, 4, 2, 1, 0} and {31, 30, 29, 27, 23, 15, 28, 26, 25, 22, 21, 14, 19, 13, 11, 24, 7, 20, 18, 12, 17, 10, 9, 6, 5, 3, 16, 8, 4, 2, 1, 0}, respectively.

Accordingly, when the indexes of K bits with the highest reliability are selected, they are determined as

$${𝒜}_{u}^{( 1 )} = \{ 15 , 14 , 13 , 11 , 7 , 12 , 10 , 9 , 6 , 5 , 3 , 8 \} and {𝒜}_{u}^{( 2 )} = \{ 31 , 30 , 29 , 27 , 23 , 15 , 28 , 26 , 25 , 22 , 21 , 14 \} .$$

### Since

$${\tilde{𝒜}}_{u}^{( 1 )} = \{ i ∈ {𝒜}_{u}^{( 1 )} \vert i + 16 \} ,$$

it can be seen that

$${\tilde{𝒜}}_{u}^{( 1 )} \backslash {𝒜}_{u}^{( 2 )} = \{ 19 , 24 \} and {𝒜}_{u}^{( 2 )} \backslash {\tilde{𝒜}}_{u}^{( 1 )} = \{ 14 , 15 \} .$$

In this case, indexes 19 and 14 and 24 and 15 are mapped 1:1 to each other, respectively. Accordingly, [symbol] ∪{14, 15}.

In the case of expanding from N⁽²⁾=32 to N⁽³⁾=48 to additionally perform a third transmission, the first 16 indexes are punctured, and among the remaining indexes 16 to 63, 12 indexes with highest reliability are chosen to compose

$${𝒜}_{u}^{( 3 )} = \{ 63 , 62 , 61 , 59 , 55 , 47 , 60 , 31 , 58 , 57 , 54 , 53 \} .$$

### Accordingly,

$${\tilde{𝒜}}_{u}^{( 2 )} \backslash {𝒜}_{u}^{( 3 )} = \{ 46 \} , {𝒜}_{u}^{( 3 )} \backslash {\tilde{𝒜}}_{u}^{( 2 )} = \{ 31 \} ,$$

and indexes 46 and 31 are mapped 1:1 to each other. Accordingly,

$${𝒜}^{( 3 )} = {\tilde{𝒜}}_{u}^{( 2 )} ⋃ \{ 31 \} .$$

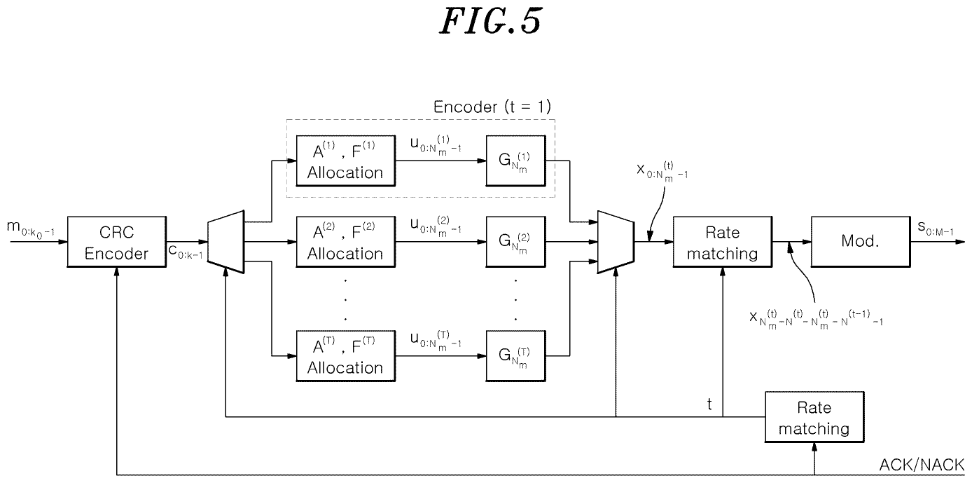

In general, the case where an i-th bit is mapped to a j-th bit (i>j) is represented as (i, j)ₚ and defined as a HARQ parity pair. That is, [symbol] is the set of parity pairs in the t-th transmission stage, and is represented as [symbol] ={(19,14)ₚ, (24,15)ₚ} and [symbol] ={(51,46)ₚ, (56,47)ₚ, (46,31)ₚ} in the example above. FIG. 5 illustrates a transmission system that transmits the same message up to T times based on the PME HARQ. K₀ bit messages m_{0:K}_{₀}₋₁ are CRC-encoded and then transmitted to an encoder of each transmission stage. A process of assigning a source bit value inside the encoder differs between an initial transmission time point and a retransmission time point. In the initial transmission stage (t=1), each bit value of the CRC-encoded vector C_{0:K-1} is fixedly assigned to the source bit

$${u}_{i}^{( 1 )} ( i ∈ {𝒜}^{( 1 )} ) ,$$

and 0 is fixedly assigned to the remaining bits. On the other hand, in the retransmission stage (t=2, 3, . . . ), the bit values are assigned by referring to [symbol] and [symbol] . The source bits to which the information bits are allocated in the initial transmission

$$( t = 1 ) moves ( {u}_{i + {N}_{m}^{( t )} - {N}_{m}^{( 1 )}}^{( 5 )} = {u}_{i}^{( 1 )} )$$

to positions where the code length increases by

$${N}_{m}^{( t )} - {N}_{m}^{( 1 )} ,$$

and bit values are assigned to positions belonging to [symbol] other than the positions according to the mapping rules defined in [symbol] . That is, the value of the source bit

$${u}_{i}^{( t )}$$

is copied to

$${u}_{j}^{( t )}$$

according to the rule (i, j)ₚ ∈ [symbol] . Thereafter, 0 may be fixedly assigned to the remaining bits.

Thereafter, a codeword

$${x}_{0 : {N}_{m}^{( t )} - 1}^{( t )}$$

having a length

$${N}_{m}^{( t )}$$

is generated through polar code encoding. In general, the encoding process in the t-th transmission stage is as shown in the following Equation 3.

$${x}_{0 : {N}_{m}^{( t )} - 1}^{( t )} = {u}_{0 : {N}_{m}^{( t )} - 1}^{( t )} {G}_{{N}_{m}^{( t )}} = {{u}_{0 : {N}_{m}^{( t )} - 1}^{( t )} [ \begin{matrix}1 & 0 \\ 1 & 1\end{matrix} ]}^{⊗ {n}^{( t )}} , ⊗ : Kronecker product \qquad [ Equation 3 ]$$

According to the polar code characteristics, the part

$${x}_{{N}_{m}^{( t )} - {N}^{( t )} : {N}_{m}^{( t )} - 1}^{( t )}$$

is composed of codeword bits transmitted in the previous transmission. Therefore, only the part

$${x}_{{N}_{m}^{( t )} - {N}^{( t )} : {N}_{m}^{( t )} - {N}^{( t - 1 )}}^{( t )} {x}_{{N}_{m}^{( t )} - {N}^{( t )} : {N}_{m}^{( t )} - {N}^{( t - 1 )}}^{( t )}$$

is transmitted in the t-th transmission. In this case, the accumulated transmission length N^{(t)} can be arbitrarily selected, but is limited to

$${N}^{( t )} = {N}_{m}^{( 1 )}$$

in the embodiment.

The PME HARQ confirms the response acknowledgment (ACK)/negative ACK (NACK) to data transmitted at each transmission stage, activates the t=1 encoder to transmit the next data when receiving ACK, and activates the encoder of the next transmission stage to transmit the same data when receiving a NACK.

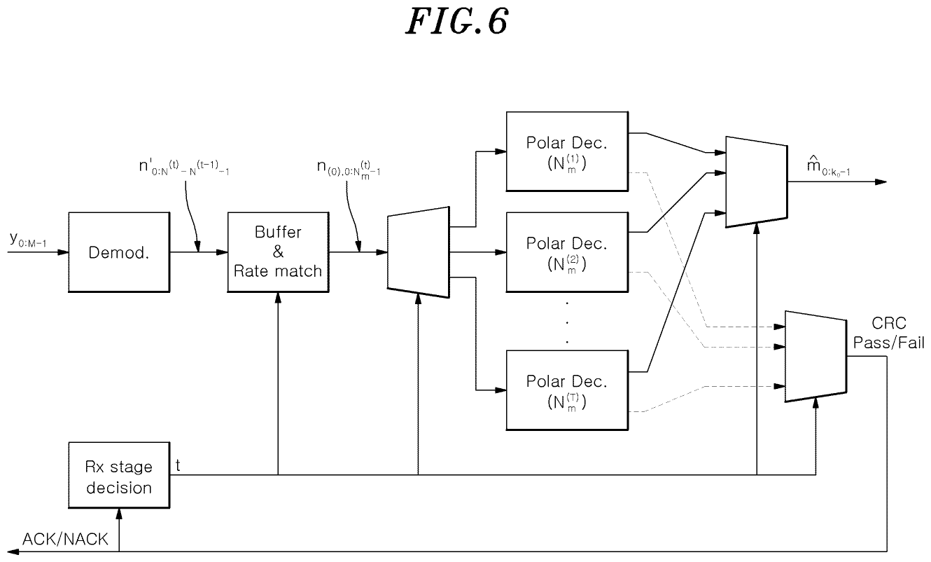

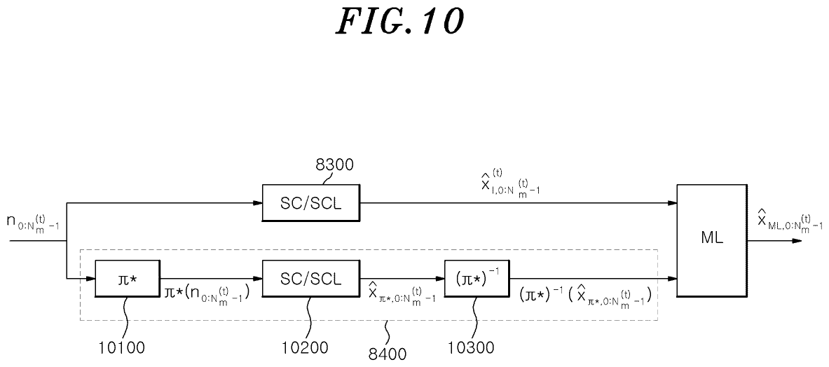

FIG. 6 illustrates the receiver structure of the PME HARQ. The receiver structure of the PME HARQ of FIG. 6 may include multiple unit decoders (Polar Dec.), and the detailed structure of the unit decoder is illustrated in FIG. 10. The buffer stores LLR corresponding to the transmitted codeword until the decoding is successful, and combines channel

$$LLR {η}_{0 : {N}^{( t )} - {N}^{( t - 1 )} - 1}^{′}$$

of an additionally received signal in the t-th transmission and

$$LLR {η}_{{N}^{( t )} - {N}^{( t - 1 )} : {N}^{( t )} - 1}^{′}$$

received in the previous transmission stages stored in the buffer to secure

$$LLR {η}_{0 : {N}_{m}^{( t )} - 1}$$

for the entire codeword. When bits omitted in the transmission according to the code rate matching are punctured, the corresponding channel LLRs are 0 (η_{(0),i}=0). In the example, the case in which the bits omitted in the transmission are shortened is excluded from the discussion.

$${η}_{0 : {N}_{m}^{( t )} - 1}$$

is input to the decoder determined according to each transmission stage, and in an embodiment, it is assumed that the SC decoding or SCL decoding method is used. In the case of the SC decoding method, the LLR value itself is used as a reliability metric, and in the case of the SCL decoding method, a LLR η₍ₙ_{^{(t)}}_{),i}-based path metric of the source bit is used to manage multiple bit estimation results. The value according to the i-th source bit estimation result ûᵢ in the path p is expressed as in the following Equation 4. It is considered that the smaller the path metric value, the higher the reliability of the corresponding bit estimation result.

$${PM}_{( {n}^{( t )} ) , i} ( p ) = \{ \begin{matrix}{PM}_{( {n}^{( t )} ) , i - 1} ( p ) + \vert {η}_{( {n}^{( t )} ) , i} \vert & {\hat{u}}_{i} = ( 1 - sgn ( {η}_{( {n}^{( t )} ) , i} ) ) / 2 \\ {PM}_{( {n}^{( t )} ) , i - 1} ( p ) & otherwise\end{matrix} \qquad [ Equation 4 ]$$

The source bit estimation method of the polar code varies depending on the type of each bit. The estimation of fixed bits and bits belonging to

$${𝒜}_{u}^{( t )}$$

is performed in the same process as the decoding process of general polar codes. The fixed bits may always be estimated as

$${\hat{u}}_{i}^{( t )} = 0 , and {𝒜}_{u}^{( t )}$$

is estimated in the following method. In the case of the SC decoding, when a η₍ₙ_{^{(t)}}_{),i} value is not negative, the source bit is estimated as

$${\hat{u}}_{i}^{( t )} = 0 ,$$

and otherwise, the source bit is estimate as

$${\hat{u}}_{i}^{( t )} = 1 ,$$

and in the case of the SCL decoding, the path metric for the candidate value of

$${\hat{u}}_{i}^{( t )}$$

is first calculated. In the process of estimating the value ûᵢ^{(t)}, the number of estimation candidates

$${\hat{u}}_{0 : i}^{( t )} ( p ) ,$$

p=0, 1, . . . , pₘₐₓ−1 is doubled, and when the number of estimation candidates exceeds L, only L candidates selected in descending order of reliability are used for the next bit estimation. In the case of the bits belonging to

$${𝒜}^{( t )} ∖ {𝒜}_{u}^{( t )} ,$$

unlike the general polar codes, the bit value is estimated based on the information of [symbol] . That is, the value of

$${\hat{u}}_{i}^{( t )}$$

is selected as the same value as

$${\hat{u}}_{j}^{( t )}$$

according to (i, j)ₚ ∈ [symbol] . The PME HARQ scenario of the example determines ACK/NACK response by checking whether the decoding is successful through the CRC check. In the case of the SCL decoding, when the decoding result does not pass the CRC check for all the L estimated candidates, it is determined as a decoding failure, so a NACK response is transmitted to a transmitting end. When there are candidates passing the CRC check among the estimated candidates in the SCL decoding, the decoding result with the highest reliability is selected and then an ACK response is transmitted.

The PME HARQ scenario achieves superior performance compared to CC HARQ in the channel through the parity bit added during the retransmission process, but the performance degradation occurs due to the characteristics of the polar code kernel structure in the block fading environment. In this case, the block fading environment means that the channel state changes for each transmission stage due to a time difference between each transmission time point of HARQ. In other words, the transmitted codeword bits may be considered to have near-identical channel gain values only when the HARQ transmission stage is the same.

In general, when a channel gain value at an i-th codeword bit transmission time point is hᵢ and a noise value is nᵢ˜ [symbol] (0, ρ²), a binary phase shift keying (BPSK) received symbol may be defined as yᵢ=hᵢsᵢ+nᵢ (sᵢ=±1). The channel LLR value for the corresponding bit is 2hᵢyᵢ/ρ², which is proportional to the channel gain value. The LLR size of the source bits additionally generated by the codeword extension decreases during the channel LLR update by min(⋅) operation, and, if either one of the LLR inputs α or β in FIG. 1 suffer from the fading, α′ may be weakened significantly while β′ has chance to endure the fading. So errors are more likely to occur at the bit positions belonging to

$${𝒜}_{u}^{( t )}$$

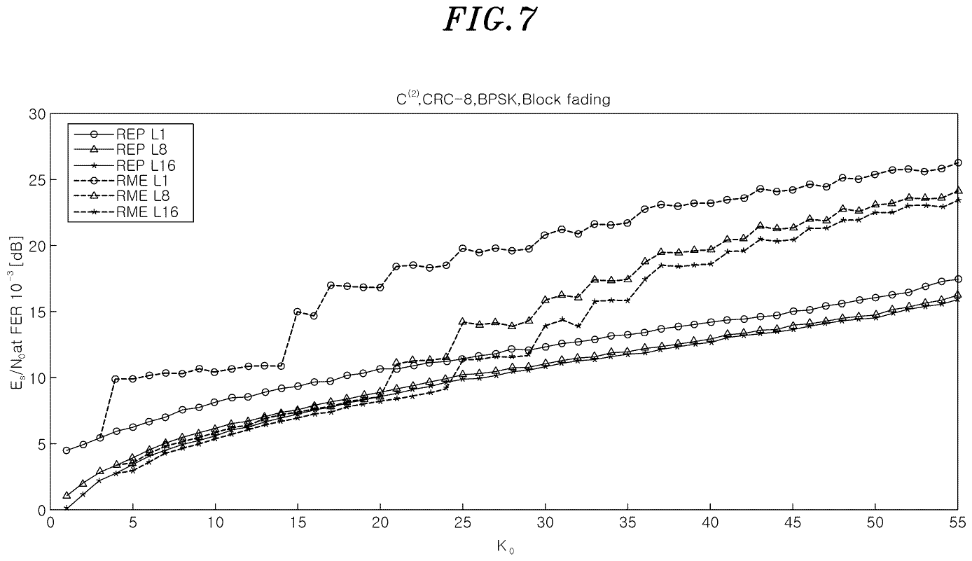

among the retransmission bits. This phenomenon can also be confirmed through the experiment below. FIG. 7 illustrates the polar code HARQ performance in the 2-th transmission stage, and illustrates the E_{S}/N₀ performance of the second transmission stage of repetition (REP), PME HARQ scenario (PME) when the same data is transmitted twice with a length of N⁽¹⁾=64. Even in the case of list decoding (L8 and L16), it is confirmed that the performance is degraded in the area where the K₀ value is high, and the cause of the performance degradation was analyzed empirically through Table 1.

TABLE 1

| K₀ | \| [symbol] \| |
|---|---|
| 4:14 | 1 |
| 15:16 | 2 |
| 17:20 | 3 |
| 21:24 | 4 |
| 25:29 | 5 |
| 30:32 | 6 |
| 33:35 | 7 |
| 36 | 8 |
| 37:40 | 9 |
| 41:42 | 10 |
| 43:45 | 11 |
| 46:47 | 12 |
| 48:49 | 13 |
| 50:51 | 14 |
| 52:54 | 15 |
| 55 | 16 |

Table 1 shows the number of parity pairs according to the message dimension K₀ in the second transmission stage of the PME HARQ. The maximum value of K₀ was set to 55 according to the use of CRC 8, and the K₀ range where the parity pair is not defined was excluded from Table 1. It can be confirmed that the additionally generated parity bits in the retransmission stage are vulnerable to fading by investigating the point where one or more parity pairs are generated from K₀=4 and the SC decoding (L1) performance is degraded first.

Therefore, the present invention provides a technology for improving the decoding performance even in the fading environment in order to solve the problem of decoding data based on the conventional PME HARQ.

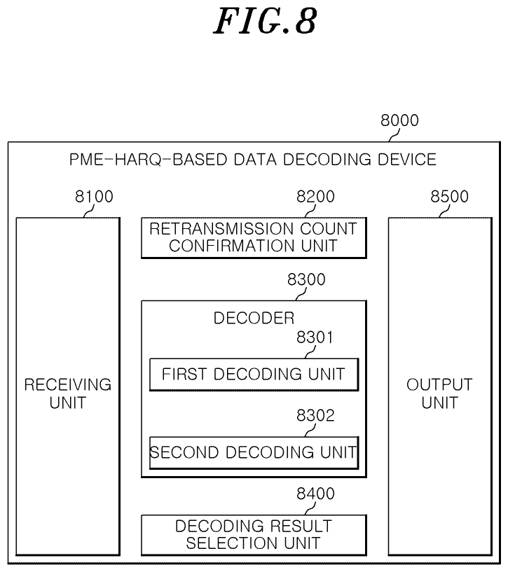

FIG. 8 is a block diagram of a PME-HARQ-based data decoding device according to an embodiment of the present invention.

Referring to FIG. 8, a PME-HARQ-based data decoding device 8000 according to an embodiment of the present invention may include a receiving unit 8100, a retransmission count confirmation unit 8200, a decoder 8300, a decoding result selection unit 8400, and an output unit 8500. Here, the decoder 8300 may include a first decoding unit 8301 and a second decoding unit 8302.

As illustrated in FIG. 5, the receiving unit 8100 may receive a data signal from a transmission system transmitting PME-HARQ-based data using an antenna, and demodulate the received signal and transmit the demodulated signal to the first decoding unit 8301 and the second decoding unit 8302.

The retransmission count confirmation unit 8200 may confirm the number of times the received PME-HARQ-based data is retransmitted.

In an embodiment, the retransmission count confirmation unit 8200 may confirm the size of the PME-HARQ-based data, the number of times of the transmissions the NACK is transmitted to the transmission system due to the decoding failure, the information bits included in the PME-HARQ-based data, etc., thereby confirming the number of times of the retransmissions, such as whether the PME-HARQ-based data is initially transmitted data or retransmitted data.

The first decoding unit 8301 may perform decoding on the PME-HARQ-based data using a decoding technique based on successive cancellation. The second decoding unit 8302 may perform the decoding on the PME-HARQ-based data using a polar code permutation technique.

In an embodiment, there may be a plurality of decoders 8300 that perform the decoding in the PME-HARQ-based data decoding device 8000. In this case, different decoders among the plurality of decoders may each be assigned according to the number of times of retransmissions. The first decoding unit 8301 and the second decoding unit 8302 may be included in one decoder 8300 of the plurality of decoders. That is, the first decoding unit 8301 and the second decoding unit 8302 are included in one decoder 8300 used in individual transmission stages, and the first decoding unit 8301 may perform the decoding on the PME-HARQ-based data using a decoding technique based on successive cancellation, and the second decoding unit 8302 may perform the decoding on the PME-HARQ-based data using the polar code permutation technique.

For a specific example, T decoders may be set based on T, which is the maximum transmission stage allowed in the system. Each decoder may be used in an individual transmission stage t. One decoder 8300 may include the first decoding unit 8301 which is a basic decoder, and the second decoding unit 8302 which is P auxiliary decoders. In this case, the P second decoding units 8302, which are different from each other, may perform decoding using different permutation patterns. In an embodiment, the P decoders mean one or more, and when P=1, that is, the best permutation pattern π* is used, the decoding performance can be improved even when the auxiliary decoder is the second decoding unit 8302. The P second decoding units 8302 may each use different permutation patterns and may have the same basic decoding algorithm.

In an embodiment, the successive cancellation-based decoding technique may be the successive cancellation (SC) decoding, the successive cancellation list (SCL) decoding, etc.

In an embodiment, the plurality of first decoding units 8301 may each decode the PME-HARQ-based data having different sizes. In the PME-HARQ-based data transmission, this is because the size of the PME-HARQ-based data increases each time data is retransmitted due to the failure of the data restoration.

In an embodiment, the second decoding unit 8302 may include: a permutation module that performs the LLR permutation on the PME-HARQ-based data based on the permutation pattern to calculate an estimated value of a codeword; a decoder that performs the successive cancellation-based decoding on the estimated value; and may include an inverse permutation module that performs LLR inverse permutation on the decoding result of the decoder.

In an embodiment, the permutation pattern of the second decoding unit 8302 may be determined based on the channel reliability of the message bits included in the PME-HARQ-based data. That is, the second decoding unit 8302 may perform the decoding on the PME-HARQ-based data by using the permutation pattern in which the number of message bits transmitted through a split channel having high channel reliability is relatively large.

In an embodiment, the reliability of each separation channel may be calculated according to the following Equation 5.

$$P W ( i ) = {\sum }_{j = 0}^{n - 1} {i}_{b , j} {β}^{j} ( β = {2}^{1 / 4} ) \qquad [ Equation 5 ]$$

$$i ↦ [ {i}_{b , n - 1} , … , {i}_{b , 1} , {i}_{b , 0} ] ( binary form )$$

In an embodiment, the plurality of second decoding units 8302 may be included in the PME-HARQ-based data decoding device 8000.

In an embodiment, when decoding the PME-HARQ-based data having different sizes, different decoding units may be selected from among the plurality of decoding units to perform the decoding. In this case, two or more selected second decoding units 8302 may perform decoding using different permutation patterns.

In an embodiment, each of the plurality of second decoding units 8302 may perform decoding using different permutation patterns.

The decoding result selection unit 8400 may select a decoding result of one of the first decoding unit 8301 and the second decoding unit 8302 based on the reliability of the decoding results of each of the first decoding unit 8301 and the second decoding unit 8302, and select a final decoding result for the PME-HARQ-based data.

In an embodiment, the decoding result selection unit 8400 may calculate the reliabilities of the decoding results of each of the first decoding unit 8301 and the second decoding unit 8302 using a maximum likelihood determination method, and compare the calculated reliabilities to select a decoding result having a relatively high reliability among the decoding results of each of the first decoding unit 8301 and the second decoding unit 8302 as the final decoding result.

The output unit 8500 may output the decoding result to a device such as a display or transmit the decoding output to an external device (not illustrated).

In addition, when the PME-HARQ-based data decoding device 8000 includes a plurality of first decoders and a plurality of second decoders, it may set a plurality of decoder groups, each of which is composed of one first decoder and one second decoder, and perform decoding by selecting one of the plurality of decoder groups according to the number of times of retransmissions.

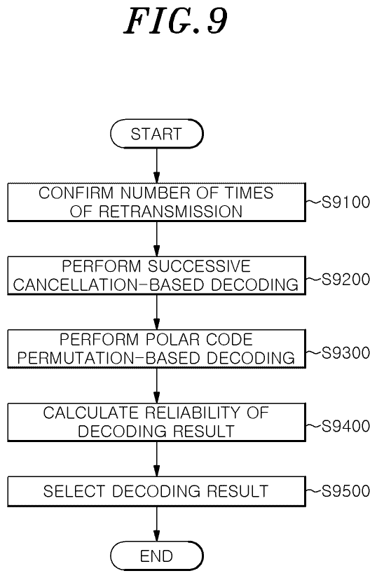

FIG. 9 is a flowchart of a method of decoding PME-HARQ-based data according to an embodiment of the present invention.

Hereinafter, the method is described as an example of being performed by the PME-HARQ-based data decoding device 8000 illustrated in FIG. 8.

In step S9100, the PME-HARQ-based data decoding device 8000 may confirm the number of times of retransmissions the received PME-HARQ-based data is retransmitted.

In an embodiment, the PME-HARQ-based data decoding device 8000 may confirm the size of the PME-HARQ-based data, the number of times of transmissions the NACK is transmitted to the transmission system due to the decoding failure, the information bits included in the PME-HARQ-based data, etc., thereby confirming the number of times of retransmissions, such as whether the PME-HARQ-based data is initially transmitted data or retransmitted data.

In step S9200, the PME-HARQ-based data decoding device 8000 includes the first decoder, and the first decoder may perform the decoding on the PME-HARQ-based data using the successive cancellation-based decoding technique.

In an embodiment, the successive cancellation-based decoding technique may be the SC decoding, the SCL, etc.

In an embodiment, the plurality of first decoding units 8301 may each decode the PME-HARQ-based data having different sizes. In the PME-HARQ-based data transmission, this is because the size of the PME-HARQ-based data increases each time data is retransmitted due to the failure of the data restoration.

In step S9300, the PME-HARQ-based data decoding device 8000 includes the second decoding unit 8302, and the second decoding unit 8302 may perform the decoding on the PME-HARQ-based data using the polar code permutation technique.

In an embodiment, the PME-HARQ-based data decoding device 8000 may perform the LLR permutation on the PME-HARQ-based data based on the permutation pattern to calculate the estimated value of the codeword, perform the successive cancellation-based decoding on the estimated value, and perform the LLR inverse permutation on the decoding result of the decoder.

In an embodiment, the permutation pattern may be set differently depending on the number of message bits included in the PME-HARQ-based data.

In an embodiment, the permutation pattern may be determined based on the channel reliability of the message bits included in the PME-HARQ-based data. That is, the PME-HARQ-based data decoding device 8000 may perform the decoding on the PME-HARQ-based data using the permutation pattern in which the number of message bits transmitted through the split channel with high channel reliability is relatively large.

In an embodiment, the PME-HARQ-based data decoding device 8000 may include the plurality of second decoding units 8302.

In an embodiment, when decoding the PME-HARQ-based data having different sizes, different decoding units may be selected from among the plurality of decoding units to perform the decoding. In this case, one or more selected second decoding units 8302 may perform decoding using different permutation patterns. At least one of the different permutation patterns may satisfy π(i)<π(j) for all parity pairs (i, j)ₚ ∈ [symbol] (i>j).

In an embodiment, the PME-HARQ-based data decoding device 8000 may perform decoding using different permutation patterns.

In step S9400, the PME-HARQ-based data decoding device 8000 may calculate the reliability of the decoding results of each of the first decoding unit 8301 and the second decoding unit 8302 using the maximum likelihood determination method.

In step S9500, the PME-HARQ-based data decoding device 8000 may select a decoding result of one of the first decoding unit 8301 and the second decoding unit 8302 based on the reliability of the decoding results of each of the first decoding unit 8301 and the second decoding unit 8302, and select a final decoding result for the PME-HARQ-based data.

In an embodiment, the PME-HARQ-based data decoding device 8000 may select a decoding result with relatively high reliability among the decoding results of each of the first decoding unit 8301 and the second decoding unit 8302 as the final decoding result.

In addition, steps S9200 and S9300 may be performed simultaneously, or one of these steps may be performed in preference to the other.

FIGS. 10 to 14 are diagrams for describing a permutation pattern according to an embodiment of the present invention.

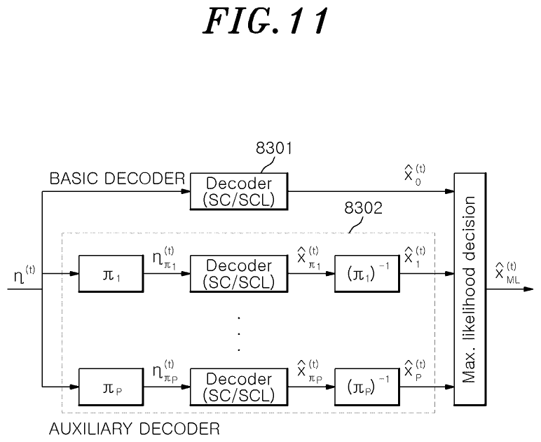

FIGS. 10 and 11. are the diagrams for describing a different decoder 8300 for each transmission stage according to an embodiment of the present invention. In the data decoding device including a first decoding unit 8301 and a second decoding unit 8302 illustrated in FIG. 11, the data decoding device reduced to a minimum-sized decoder using only one x pattern is illustrated in FIG. 10.

Referring to FIG. 10, when the PME-HARQ-based data decoding device 8000 receives PME-HARQ-based

$$data {η}_{0 : {N}_{m}^{( t )} - 1} ,$$

the first decoding unit 8301 may perform the successive cancellation-based decoding on the PME-HARQ-based data

$${η}_{0 : {N}_{m}^{( t )} - 1}$$

to output first data

$${\hat{x}}_{I , 0 : {N}_{m}^{( t )} - 1} .$$

The permutation module of the second decoding unit 8302 may perform the LLR permutation on the PME-HARQ-based data

$${η}_{0 : {N}_{m}^{( t )} - 1}$$

using the permutation pattern π* to calculate an estimated value

$${π}^{*} ( {η}_{0 : {N}_{m}^{( t )} - 1} )$$

of the codeword. In an embodiment, the permutation module of the second decoding unit 8302 may also perform the LLR permutation on the PME-HARQ-based data

$${η}_{0 : {N}_{m}^{( t )} - 1}$$

using π₁, . . . , πₚ, which can invert the decoding order of all the parity pairs, in addition to the permutation pattern π*, to calculate the estimated value

$${π}^{*} ( {η}_{0 : {N}_{m}^{( t )} - 1} )$$

of the codeword. The decoder of the second decoding unit 8302 may perform the successive cancellation-based decoding on the estimated value

$${π}^{*} ( {η}_{0 : {N}_{m}^{( t )} - 1} )$$

of the codeword to calculate

$${\hat{x}}_{{π}^{*} , 0 : {N}_{m}^{( t )} - 1}^{( t )} .$$

The inverse permutation module of the second decoding unit 8302 may perform LLR inverse permutation (π*)⁻¹ on the decoding result.

$${\hat{x}}_{{π}^{*} , 0 : {N}_{m}^{( t )} - 1}^{( t )}$$

of the decoder to output the second data

$${\hat{x}}_{1}^{( t )} = {( {π}^{*} )}^{- 1} ( {\hat{x}}_{{π}^{*} , 0 : {N}_{m}^{( t )} - 1}^{( t )} ) .$$

The decoding result selection unit 8400 may select one of the higher reliability of the first data

$${\hat{x}}_{I , 0 : {N}_{m}^{( t )} - 1}^{( t )}$$

and the second data

$${\hat{x}}_{1}^{( t )}$$

as the final decoding result

$${\hat{x}}_{ML , 0 : {N}_{m}^{( t )} - 1}^{( t )}$$

according to the maximum likelihood (ML) determination method. In the second decoding unit, P≥1 or more permutation decoder modules may be used. In this case, the maximum likelihood determination method may be used for P+1 data

$${\hat{x}}_{0}^{( t )} , … , {\hat{x}}_{P}^{( t )}$$

to determine

$${\hat{x}}_{ML , 0 : {N}_{m}^{( t )} - 1}^{( t )} .$$

In an embodiment, the maximum likelihood determination method is based on LLR η_{(0),i} corresponding to each bit estimated value

$${\hat{x}}_{i}^{( t )}$$

of the codeword and determines that the higher the value is according to the following Equation 6, the more reliable the corresponding estimation result is, and the function 1_{A}(x) is a function that outputs 1 when x belongs to A={\hat{x}|\hat{x}=(1−sgn(η₍₀₎))/2}, and otherwise, outputs 0.

$$S = {\sum }_{i = 0}^{{N}_{m}^{( t )} - 1} {1}_{A} ( {\hat{x}}_{i} ) \vert {η}_{( 0 ) , i} \vert \qquad [ Equation 6 ]$$

The second decoder operates in a state where the decoding order of the parity pair (i, j)ₚ is reconstructed according to the permutation pattern π*. That is, for (i, j)ₚ∈ [symbol] , when π*(i)<π*(j), the value of

$${\hat{u}}_{{π}^{*} ( j )}^{( t )}$$

is selected as

$${\hat{u}}_{{π}^{*} ( i )}^{( t )} .$$

In the case of P≥2, there may be (i, j)ₚ∈ [symbol] that π_{φ}(i)<π_{φ}(j) is not satisfied for π_{φ}(φ=1, . . . , P). In this case, the value of

$${\hat{u}}_{{π}_{ϕ} ( i )}^{( t )}$$

### is Selected as

$${\hat{u}}_{{π}^{*} ( j )}^{( t )} .$$

In the example, a single pattern π* that guarantees the sufficient performance in all dimensions

$$K ∈ \{ 0 : {N}_{m}^{( 1 )} - 1 \}$$

may be searched and determined in advance. In particular, in the third transmission or later stages, the configuration of the parity pair is partially changed before the π* search in order to maximize the performance enhancement. Specifically, when the parity pairs (i, j)ₚ and (j, k)ₚ exist in [symbol] at the same time, (j, k)ₚ is updated to (i, k)ₚ. The final update result is stored as [symbol] , separated from [symbol] . As illustrated in FIG. 11, in the case of [symbol] 32 {(51,46)ₚ, (56,47)ₚ, (46,31)ₚ}, (46,31)ₚ is changed to (51,31)ₚ, so [symbol] ={(53,46)ₚ, (56,47)ₚ, (51,31)ₚ} [symbol] ={(51,46)ₚ, (56,47)ₚ, (51,31)ₚ}.

The bit indicated by the index i in (i, j)ₚ∈ [symbol] is always the bit transmitted at the first transmission time point. This is to take advantage of the phenomenon where transmitted bits become most reliable when t=1 in the block fading environment according to the characteristics of the polar code kernel structure.

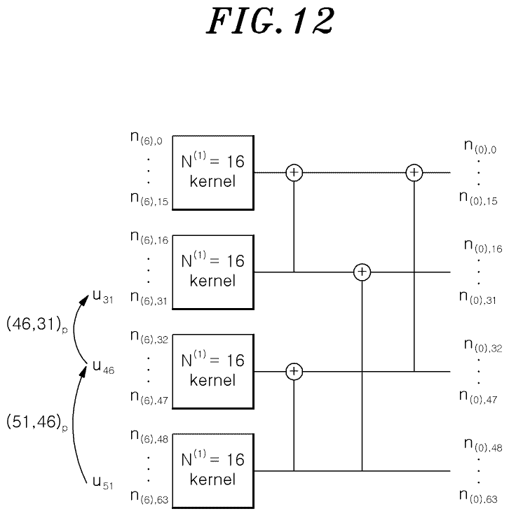

FIG. 12 is a flowchart of a method of finding an optimal permutation pattern. The π* search procedure first temporarily stores the set

$${A}_{o}^{( c )} = \{ i + {N}_{m}^{( c )} - {N}_{m}^{( 1 )} 1 i ∈ {A}^{( 1 )} \}$$

of polar code information bit indexes and [symbol] at all K values. Thereafter, the suitability of all the π patterns as the decoder samples is checked. In the first step, it is checked whether the π pattern can invert the bit estimation directions of all the parity pairs of [symbol] for the given K. In other words, it proceeds to the next step only for the π pattern that satisfies π(i)<π(j) for all (i, j)ₚ∈ [symbol] . For the π pattern that passes the first step, the sample reliability is determined by comparing the PW values of the results of permuting all the indexes of

$${𝒜}_{o}^{( t )} = \{ i + {N}_{m}^{( t )} - {N}_{m}^{( 1 )} \vert i ∈ {𝒜}^{( 1 )} \}$$

in each dimension. Specifically, it is considered that the values according to Equation 7 are compared between different π patterns, and thus, the larger the value, the better the corresponding π pattern is. In this case, the PW(⋅) is a function that calculates the PW value of the input index.

$${μ}_{K} = {min}_{i ∈ {𝒜}_{o}^{( t )}} \{ PW ( π ( i ) ) \} \qquad [ Equation 7 ]$$

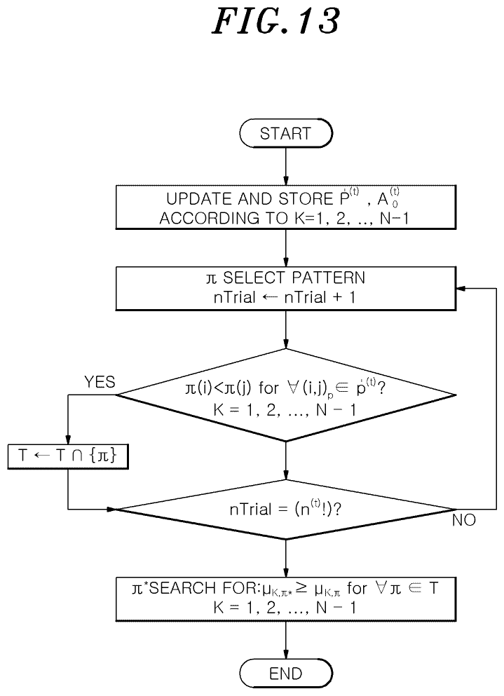

Here, the PW value is an example for description, and a method of finding the optimal permutation pattern may be performed by using a metric other than the PW. FIG. 13 is a diagram for describing an example of selecting an LLR permutation pattern.

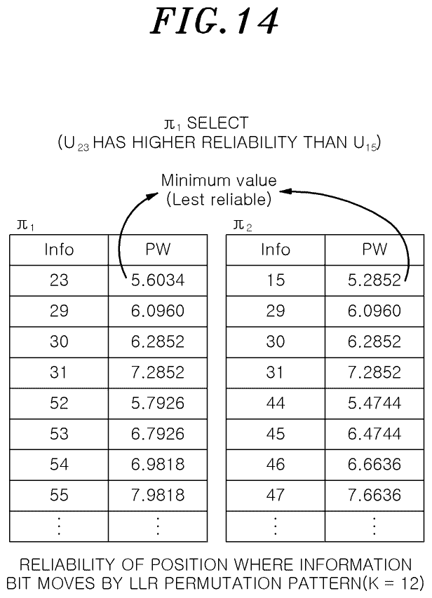

Referring to FIG. 14, it can be seen that the information bits

$${u}_{i}^{( t )} , i ∈ {𝒜}_{o}^{( t )}$$

move to a new position

$${u}_{π ( i )}^{( t )}$$

by each permutation pattern π at each retransmission stage of the PME HARQ, and the reliability information for the corresponding positions is organized as PW. Among these, the positions with the lowest reliability may be selected one by one for each π pattern, so the reliabilities may be compared with each other. As a result of the comparison, π with the highest reliability may be selected as π*.

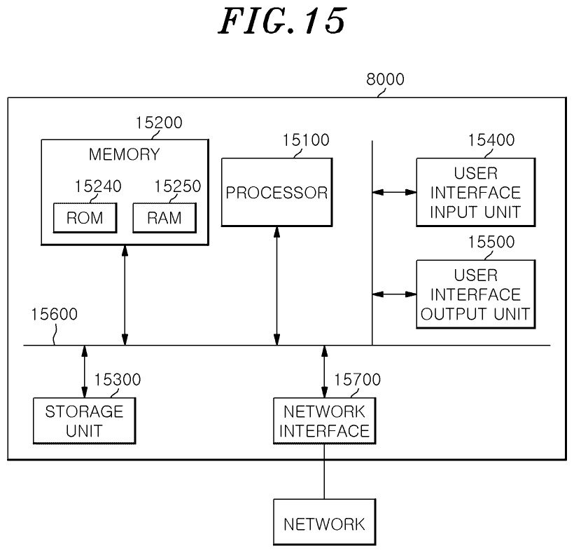

FIG. 15 is a block diagram of a PME-HARQ-based data decoding device according to another embodiment of the present invention.

As illustrated in FIG. 15, a PME-HARQ-based data decoding device 8000 includes at least one component of a processor 15100, a memory 15200, a storage unit 15300, a user interface input unit 15400, and a user interface output unit 15500, which may communicate with each other via a bus 15600. In addition, the PME-HARQ-based data decoding device 8000 may also include a network interface 15700 for connecting to a network. The processor 15100 may be a CPU or a semiconductor element executing processing instructions stored in the memory 15200 and/or the storage unit 15300. The memory 15200 and the storage unit 15300 may include various types of volatile/non-volatile storage media. For example, the memory may include a ROM 15240 and a RAM 15250.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A PME-HARQ-based data decoding device, comprising:
at least one first decoding unit that performs successive cancellation-based decoding on PME-HARQ-based data;
at least one second decoding unit that performs polar code permutation-based decoding on the PME-HARQ-based data; and
a decoding result selection unit that selects one of decoding results of the first decoding unit and decoding results of the second decoding unit based on a reliability of the decoding results of the first decoding unit and a reliability of the decoding results of the second decoding unit.

2. The PME-HARQ-based data decoding device of claim 1, wherein the second decoding unit includes:
a permutation module that performs LLR permutation on the PME-HARQ-based data based on a kernel permutation pattern to calculate an estimated value of a codeword;
a decoder that performs successive cancellation-based decoding on the estimated value; and
an inverse permutation module that performs LLR inverse permutation on the decoding result of the second decoding unit.

3. The PME-HARQ-based data decoding device of claim 2, further comprising:
a retransmission count confirmation unit that confirms a number of times the PME-HARQ-based data is retransmitted,
wherein different decoders are each selected from among a plurality of decoders according to a number of times of retransmissions, and
the first decoding unit and the second decoding unit are included in one of the plurality of decoders.

4. The PME-HARQ-based data decoding device of claim 3, wherein a number of the second decoding units is plural, and
a permutation pattern used by each of a plurality of second decoding units is configured so that a decoding order determined by all parity pairs is inverted.

5. The PME-HARQ-based data decoding device of claim 1, wherein the PME-HARQ-based data has different code lengths according to a number of times of retransmissions.

6. The PME-HARQ-based data decoding device of claim 2, wherein the kernel permutation pattern is set differently according to a number of message bits included in the PME-HARQ-based data.

7. The PME-HARQ-based data decoding device of claim 2, wherein the kernel permutation pattern is determined based on a channel reliability of a message bit included in the PME-HARQ-based data.

8. The PME-HARQ-based data decoding device of claim 1, wherein the PME-HARQ-based data is t-th (natural number greater than or equal to 1) retransmitted data after an initial transmission failure.

9. The PME-HARQ-based data decoding device of claim 1, wherein the successive cancellation-based decoding is successive cancellation (SC) decoding or successive cancellation list (SCL) decoding.

10. The PME-HARQ-based data decoding device of claim 1, wherein the decoding result selection unit compares the reliabilities using a maximum likelihood determination method and selects the decoding result of one of the first decoding unit and the second decoding unit.

11. The PME-HARQ-based data decoding device of claim 2, wherein the kernel permutation pattern is a single permutation pattern according to a number of message bits.

12. The method for decoding PME-HARQ-based data performed by a PME-HARQ-based data decoding device, the method comprising:
performing, by using at least one first decoding unit, successive cancellation-based decoding on PME-HARQ-based data;
performing, by using at least one second decoding unit, polar code permutation-based decoding on the PME-HARQ-based data; and
selecting one of decoding results of the first decoding unit and decoding results of the second decoding unit based on a reliability of the decoding results of the first decoding unit and a reliability of the decoding results of the second decoding unit.

13. The method of claim 12, wherein in performing the polar code permutation-based decoding,
performing LLR permutation on the PME-HARQ-based data based on a kernel permutation pattern to calculate an estimated value of a codeword;
performing successive cancellation-based decoding on the estimated value; and
performing LLR inverse permutation on the decoding result of the second decoding unit.

14. The method of claim 13, the method further comprising:
confirming a number of times the PME-HARQ-based data is retransmitted; and
selecting each different decoders from among a plurality of decoders according to a number of times of retransmissions,
wherein the first decoding unit and the second decoding unit are included in one of the plurality of decoders.

15. The method of claim 14, a number of the second decoding units is plural, and
a permutation pattern used by each of a plurality of second decoding units is configured so that a decoding order determined by all parity pairs is inverted.

16. The method of claim 12, wherein the PME-HARQ-based data has different code lengths according to a number of times of retransmissions.

17. The method of claim 13, wherein the kernel permutation pattern is set differently according to a number of message bits included in the PME-HARQ-based data.

18. The method of claim 13, wherein the kernel permutation pattern is determined based on a channel reliability of a message bit included in the PME-HARQ-based data.

19. The method of claim 11, wherein the PME-HARQ-based data is t-th (natural number greater than or equal to 1) retransmitted data after an initial transmission failure.

20. The non-transitory computer-readable storage medium storing a computer program, wherein the computer program, when executed by a processor, comprises an instruction for causing the processor to perform a method comprising:
performing, by using at least one first decoding unit, successive cancellation-based decoding on PME-HARQ-based data;
performing, by using at least one second decoding unit, polar code permutation-based decoding on the PME-HARQ-based data; and
selecting one of decoding results of the first decoding unit and decoding results of the second decoding unit based on a reliability of the decoding results of the first decoding unit and a reliability of the decoding results of the second decoding unit.
